(19) United States
(12) Patent Application Publication
(10) Pub. No.: US 2011/0018806 A1
(43) Pub. Date: Jan. 27, 2011

(54) INFORMATION PROCESSING APPARATUS, COMPUTER READABLE MEDIUM, AND POINTING METHOD

(75) Inventor: Keijiro YANO, Tachikawa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/842,852

(22) Filed: Jul. 23, 2010

(30) Foreign Application Priority Data
Jul. 24, 2009 (JP) 2009-173742

(51) Int. Cl. G06F 3/033; G06F 3/048

(52) U.S. Cl. 345/163; 715/856

(57) ABSTRACT

According to one embodiment, an information processing apparatus includes a display module, a coordinate information generation module, a cursor display module, and a processing module. The display module displays image information on a display screen. The coordinate information generation module detects that objects are simultaneously contacted with or approached to first and second detection points of the display screen, and generates coordinate information of the first and second detection points. The cursor display module displays a cursor on the display screen. The processing module, when the coordinate information generation module detects that the objects are contacted with or approached to the first and second detection points and the first detection point exists on the cursor, generates a predetermined event which corresponds to an input operation of a mouse, in accordance with the coordinate information of the second detection point.

### CROSS-REFERENCE TO RELATED APPLICATIONS

This application is based upon and claims the benefit of priority from Japanese Patent Application No. 2009-173742, filed Jul. 24, 2009; the entire contents of which are incorporated herein by reference.

### FIELD

Embodiments described herein relate generally to an information processing apparatus including a touch panel and, to a method, a computer readable medium, and information processing apparatus of performing a pointing operation on the screen of a touch panel capable detecting a multi-touch.

### BACKGROUND

For a recent personal computer (PC) or the like, a touch panel by which various input operations can be performed on the PC by directly touching the display screen of a displayed image has been developed. In normal touch panel operations, a selecting operation (equivalent to the left click of mouse operations) is often performed by a tapping operation of touching a portion to be pointed on the display screen for a short time period, and no cursor is in many cases displayed unlike in mouse operations.

PC operations using a mouse, however, have many user-friendly functions such as a mouseover function of displaying information by resting a cursor on an icon without any predetermined selecting operation, and a function of displaying a context menu by right click. Since these functions cannot be input without displaying a cursor or by a touch panel tapping operation, users often feel inconvenience.

Accordingly, an input control method capable of emulating a mouse by a touch panel operation even in a pointing operation using a touch panel has been proposed (see Jpn. Pat. Appln. KOKAI Publication No. 2006-179006).

This input control method according to the above proposal emulates input operations using a mouse, but cannot provide any intuitive operation feeling. For example, the user must release his or her finger once when performing a series of operations.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary perspective view showing an example of the external appearance of a PC according to an embodiment.

FIG. 2 is an exemplary block diagram showing an example of the hardware configuration of the PC according to the embodiment.

FIG. 3 is an exemplary view showing an example of a cursor display method according to the embodiment.

FIG. 4 is an exemplary view showing another example of the cursor display method according to the embodiment.

FIG. 5 is an exemplary view showing an example of a mouse emulation input method according to the embodiment.

FIG. 6 is an exemplary view showing an example of the display in an LCD by a mouseover function according to the embodiment.

FIGS. 7A and 7B are exemplary views showing an example of a method of implementing a cursor display changing function according to the embodiment.

FIG. 8 is an exemplary functional block diagram showing examples of functional blocks of the PC according to the embodiment.

FIG. 9 is an exemplary view showing an input discrimination method of a click discrimination module and examples of processing based on each discrimination according to the embodiment.

FIG. 10 is an exemplary flowchart showing an example of the procedure according to the embodiment.

FIG. 11 is an exemplary flowchart showing an example of the procedure of a cursor display phase according to the embodiment.

### DETAILED DESCRIPTION

Various embodiments will be described hereinafter with reference to the accompanying drawings.

In general, according to one embodiment, an information processing apparatus includes a display module, a coordinate information generation module, a cursor display module, and a processing module. The display module displays image information on a display screen. The coordinate information generation module detects that objects are simultaneously contacted with or approached to first and second detection points on the display screen, and generates coordinate information of the first and second detection points. The cursor display module displays a cursor on the display screen. The processing module, when the coordinate information generation module detects that the objects are contacted with or approached to the first and second detection points and the first detection point exists on the cursor, generates a predetermined event which corresponds to an input operation of a mouse, in accordance with the coordinate information of the second detection point.

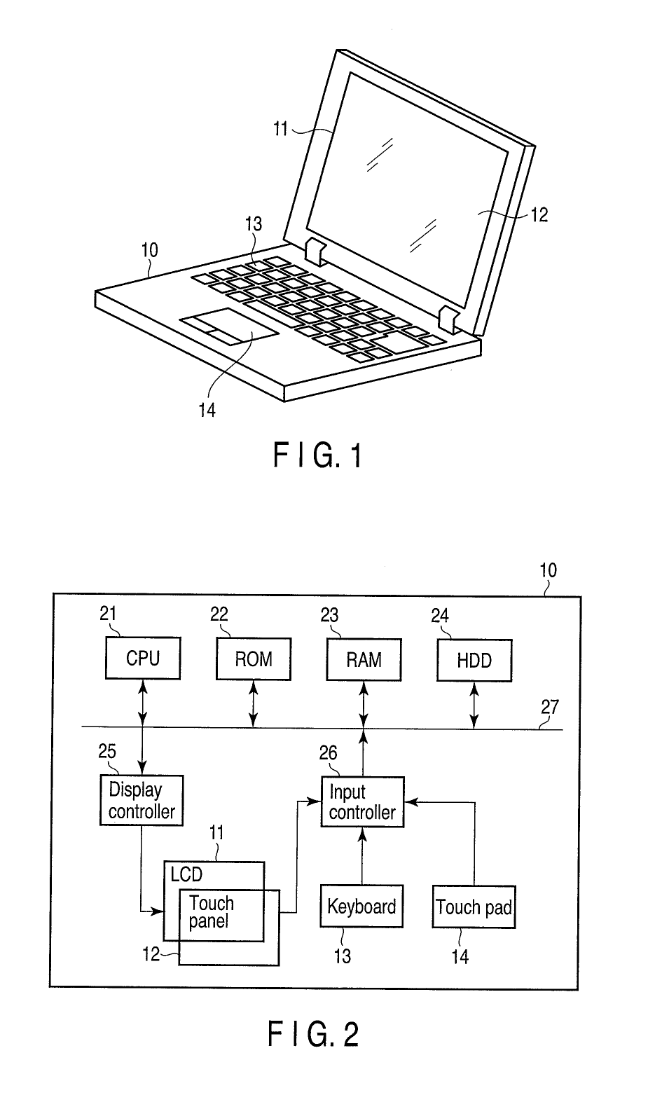

FIG. 1 is a perspective view showing an example of an external appearance of a PC 10 according to an embodiment. FIG. 1 shows the PC 10, an LCD 11, a touch panel 12, a keyboard 13, and a touch pad 14.

The PC 10 is an information processing apparatus for performing various calculation processes in accordance with user's instructions. Also, the PC 10 has a touch panel function of detecting the contact or proximity of an object to the display screen, and performing various kinds of processing by using the detection results. Although this embodiment uses a PC as an example of the information processing apparatus, the embodiment is not limited to this and applicable to various information processing apparatuses such as a PDA.

The LCD (Liquid Crystal Display) 11 is a display device having the function of displaying image information from the PC 10 to the user. Although this embodiment uses a liquid crystal display as the display device, any display device capable of displaying image information is usable, so it is possible to use various display devices such as a plasma display.

The touch panel 12 is provided on the screen of the LCD 11, and has a function of detecting the contact or proximity of an object, and outputting the detection information as an electrical signal to the PC 10. The touch panel 12 is also capable of detecting a multi-touch as the simultaneous contact or proximity of objects at two points. The simultaneous contact or proximity of objects to the touch panel 12 at two points will be called a multi-touch. The contact or proximity of an object to the touch panel 12 at only one point will be called a single touch. As the touch panel 12 is transparent, the user can see the display of the LCD 11 through the transparent touch panel 12.

The keyboard 13 has a function of detecting user's key pressing, and outputting the detection information as an electrical signal to the PC 10.

The touch panel 14 has a function of detecting the movement of a user's finger on the screen of the touch panel 12, and outputting the detection information as an electrical signal to the PC 10.

FIG. 2 is a block diagram showing an example of the hardware configuration of the PC 10 according to this embodiment. FIG. 2 shows the PC 10, a CPU 21, a ROM 22, a RAM 23, an HDD 24, a display controller 25, the LCD 11, the touch panel 12, an input controller 26, the keyboard 13, the touch pad 14, and a bus 27.

The CPU (central processing unit) 21 controls the whole PC 10. The CPU 21 also has a function of executing an operating system (OS) and various programs such as a touch input application program, which are loaded from the HDD 24 into the RAM 23. The CPU executes predetermined processing corresponding to each program.

The ROM 22 includes a semiconductor memory storing the programs to be executed by the CPU 21. The ROM 22 also includes BIOS for hardware control.

The RAM 23 includes a semiconductor memory, and is used as a program/data storage area when the CPU 21 processes the programs.

The HDD 24 includes, e.g., a magnetic disk device, and is used as a nonvolatile area for storing data of the PC 10. The stored programs and data are be read by instructions from the CPU 21. The HDD 24 also stores the touch input application program for controlling multi-touch input. This touch input application program will be described later.

The display controller 25 is an image processing semiconductor chip, and has a function of drawing images in accordance with drawing instructions from the CPU 21 or the like, and outputting the images to the LCD 11.

The input controller 26 controls information input by the user using the touch panel 12, keyboard 13, and touch pad 14, and outputs the information to the PC 10.

The bus 27 connects the modules in the PC 10 such that these modules can communicate with each other.

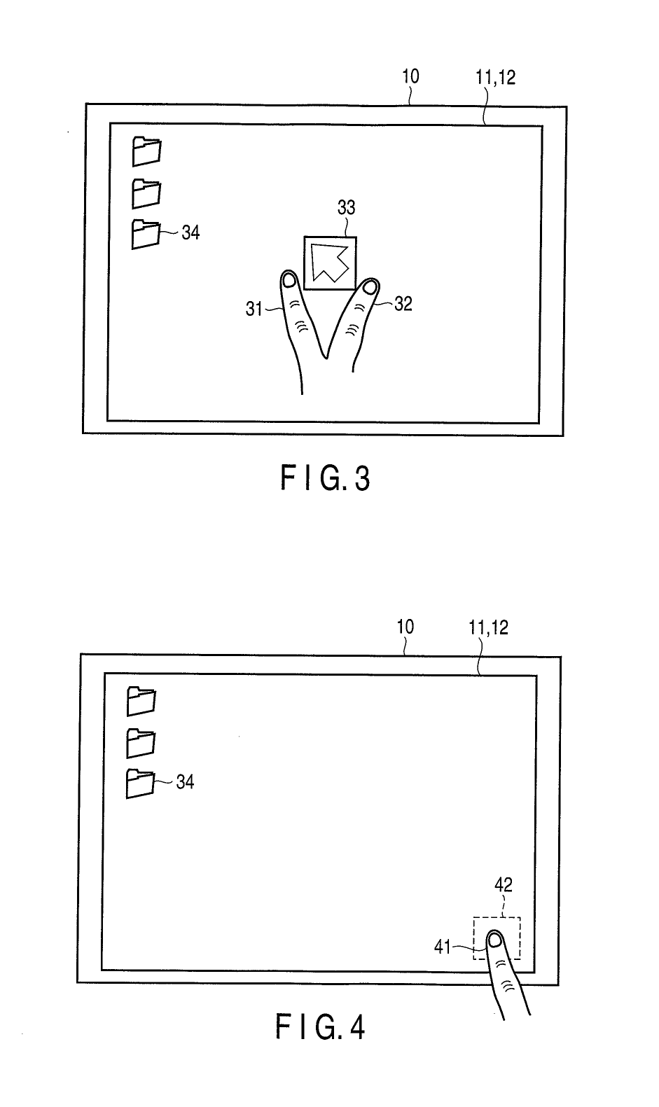

FIG. 3 is a view showing an example of a cursor display method according to this embodiment. FIG. 3 shows the PC 10, the LCD 11, the touch panel 12, fingers 31 and 32, a cursor 33, and a folder 34.

The fingers 31 and 32 are the fingers of the user operating the PC 10. The user can give various instructions to the PC 10 by touching or approaching the touch panel 12 with one or both of the fingers 31 and 32.

The cursor 33 is a selection display for, e.g., selecting an object on the display screen of the LCD 11. The user can point an object existing at the arrowhead of the cursor 33 to select the object by moving the cursor 33. The PC 10 displays the cursor 33 in a size larger than that of a touch point where the finger touches or approaches the touch panel 12. By thus displaying the cursor 33 in a large size, the cursor 33 is not hidden behind the finger when the user is touching the cursor 33 with the finger. This allows the user to always perform an input operation while seeing the cursor 33.

If the cursor 33 is not displayed, when selecting, e.g., an object smaller than the touch point where the user's finger touches the touch panel 12, the object is hidden behind the finger. This makes it difficult for the user to discriminate whether the target object is correctly selected, thereby degrading the user friendliness. When the cursor 33 is displayed in a large size as described above, an object is selected by the arrowhead of the cursor 33. Therefore, the user can readily see an object to be selected, and can easily select even a small object.

The folder 34 is a display object indicating the storage destination of data or the like to be used by the user. By selecting the folder 34, the user can refer to the storage destination of data to be used.

In this embodiment, the cursor 33 is not displayed on the LCD 11 in the initial state. When the user taps an object as a selection target with the finger in this state, the tapped object is selected. “Tap” means an operation of touching the touch panel 12 for a relatively short predetermined time or less. There is also an input operation called “drag” different from “tap”. “Drag” is an input operation of continuously touching the touch panel 12 for a time period longer than the above-mentioned predetermined time.

In this embodiment, the PC 10 displays the cursor 33 on the LCD 11 when the user taps the touch panel 12 with the fingers 31 and 32 at the same time (a multi-touch) as shown in FIG. 3. In this case, the PC 10 displays the cursor 33 at the middle point between the two detected contact points (the touch points of the fingers 31 and 32) on the touch panel 12. Although the cursor 33 is displayed at the middle point between the two detected contact points in this embodiment as described above, this is merely an example, and the display position is not limited to this. An example of the way the cursor 33 is displayed by multi-touch contact is to display the cursor 33 at a point touched by one of the fingers. It is also possible to set an initial value such that the cursor 33 is displayed in the center (or the lower right corner or the like) of the LCD 11 regardless of contact points on the touch panel 12. Furthermore, in this embodiment, the cursor 33 is erased if no input operation using the cursor 33 has been received from the user for a predetermined time or more (this will be explained later). To display the cursor 33 after it is erased, the cursor 33 may be displayed in a position where the cursor 33 was displayed immediately before it was erased. It is also possible to combine the above-mentioned methods.

FIG. 4 is a view showing an example of a cursor display method according to this embodiment. FIG. 4 shows the PC 10, the LCD 11, the touch panel 12, the folder 34, a finger 41, and a cursor display area 42. An example of a display method different from the method of displaying the cursor 33 shown in FIG. 3 will be explained below.

In the cursor display area 42 on the display of the LCD 11, the PC 10 displays the cursor 33, when the user performs an input operation by tapping using the finger 41.

Referring to FIG. 3, the cursor 33 is displayed by a multi-touch by the user. However, it is also possible to display the cursor 33 by tapping the cursor display area 42 as shown in FIG. 4. The cursor display area 42 is always displayed when the cursor 33 is undisplayed. When the cursor 33 is displayed by tapping the cursor display area 42 by the user, the cursor display area 42 may be kept displayed and may also be erased. When the cursor display area 42 is undisplayed while the cursor 33 is displayed, the display on the LCD 11 is easy to see because there is no extra display. When the cursor display area 42 is kept displayed while the cursor 33 is displayed, the displayed cursor 33 may also be erased if the user taps the cursor display area 42. In this case, the cursor display area 42 functions as a user's operation input area for switching the display and non-display of the cursor 33 like a toggle switch. Furthermore, although the cursor display area 42 is displayed in the lower right corner on the screen of the LCD 11 in this embodiment, the display position may appropriately freely be designed.

The display and non-display of the cursor 33 may also be switched by pressing a predetermined key (or simultaneously pressing two predetermined keys or the like) of the keyboard 13, or pressing a dedicated button provided on the PC 10.

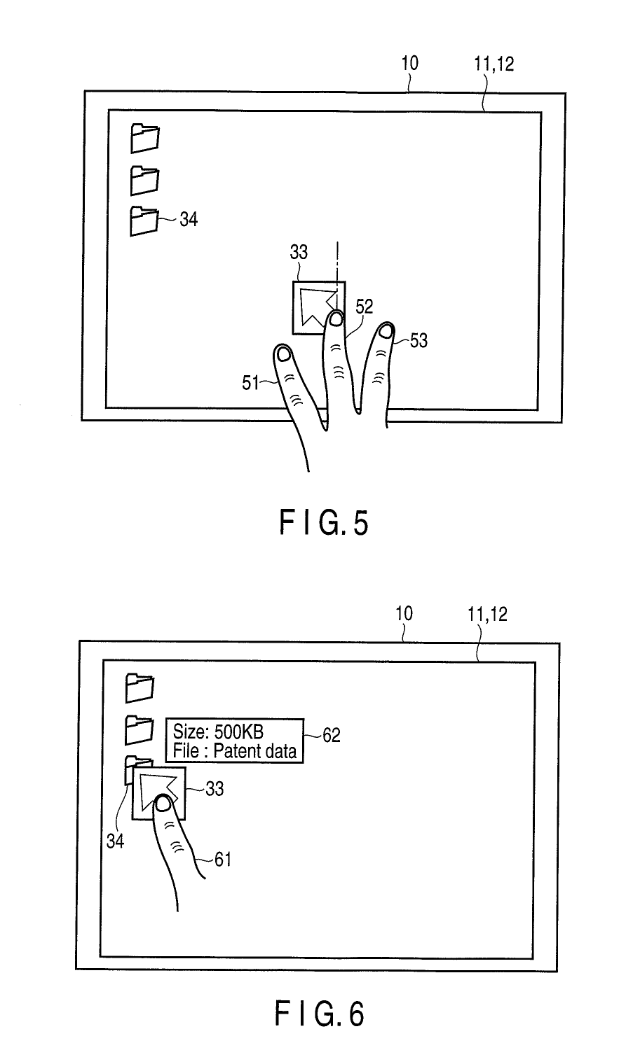

FIG. 5 is a view showing an example of a mouse emulation input method according to this embodiment. FIG. 5 shows the PC 10, the LCD 11, the touch panel 12, the cursor 33, the folder 34, and fingers 51, 52, and 53.

When the user moves the finger 52 while dragging the cursor 33 displayed as shown in FIG. 5 (while touching the display of the cursor 33 for a predetermined time or more), the cursor 33 moves following the movement of the finger 52 (in the same moving direction by the same moving amount as the finger 52).

The user can perform the left click of mouse input by tapping the left side of the finger 52 (the left side of the one-dot dashed line on the screen) with another finger 51. The user can also perform the right click of mouse input by tapping the right side of the finger 52 (the right side of the one-dot dashed line on the screen) with another finger 53. That is, a left-click event occurs when the user taps the left side of the finger 52, and a right-click event occurs when the user taps the right side of the finger 52.

With this configuration, the PC 10 can perform mouse emulation that allows the user to perform intuitive operations. When using a mouse, the user usually performs a clicking operation with two fingers. In this embodiment, the multi-touch function can simultaneously detect the touch points of two fingers 51, 52. Unlike a single-touch input operation, therefore, the user can perform an input operation on the touch panel 12 of the PC 10 by using fingers by the same feeling as that of a normal mouse input operation.

When the user successively inputs two taps of the left side of the one-dot dashed line shown in FIG. 5 with the finger 51 within a predetermined time, for example, the same event as that occurs when double click is performed by the left click of a mouse occurs.

The user can also simply set the range of a selection region by moving the finger 52 while touching the left side of the finger 52 on the touch panel 12 with the finger 51. When the finger 51 touches the touch panel 12, a rectangular region having, as diagonal points, a point on the display screen at which the arrowhead of the cursor 33 exists when the touch by the finger 51 starts and a point at which the arrowhead of the cursor 33 exits when the touch ends is set as a selection region. When setting the range of a selection region by an input operation using the touch panel 12, the procedure of releasing the finger once is necessary in a single-touch operation. This makes it difficult to set the range of a selection region by an intuitive operation. On the PC 10 according to this embodiment, however, the user can intuitively set the range of a selection region without following any procedure of, e.g., releasing the finger once.

FIG. 6 is a view showing an example of the display of the LCD 11 when achieving a mouseover function according to this embodiment. FIG. 6 shows the PC 10, the LCD 11, the touch panel 12, the cursor 33, the folder 34, a finger 61, and a tooltip 62.

While the cursor 33 is displayed in this embodiment, the PC 10 achieves the mouseover function when the user drags the cursor 33 with the finger 61 and rests the cursor 33 on an object such as the folder 34 for a predetermined time. The mouseover function herein mentioned is a function by which the PC 10 performs predetermined processing when the user rests the cursor 33 on an object such as the folder 34 without selecting the object by left click or the like. In this embodiment, when the user rests the cursor 33 on the folder 34 for a predetermined time without any selecting process, the PC 10 displays information concerning the folder 34 in the tooltip 62 by the mouseover function. The information displayed in FIG. 6 contains the folder size and folder name. Referring to FIG. 6, the folder 34 has a folder name “patent data”, and a folder size of 500 KB. In this embodiment, the mouseover function is explained by the above-described process (the tooltip 62 displays the information of the folder 34 when the cursor 33 is rested on the folder 34). However, the embodiment is not limited to this, and various kinds of processing exist as the mouseover function. For example, an object presently pointed by the arrow of the cursor 33 may be highlighted by emphasizing the contour of the object.

The tooltip 62 disappears when the cursor 33 is removed from the folder 34. On the other hand, the tooltip 62 is kept displayed even when the user stops touching the touch panel 12 and releases the finger from the touch panel 12 while the cursor 33 exists on the display of the folder 34. These are examples of the processing performed by the PC 10 after the tooltip 62 is displayed, and the embodiment is not limited to these examples.

As described above, this embodiment can achieve the mouseover function since the cursor 33 is displayed in the touch panel input method.

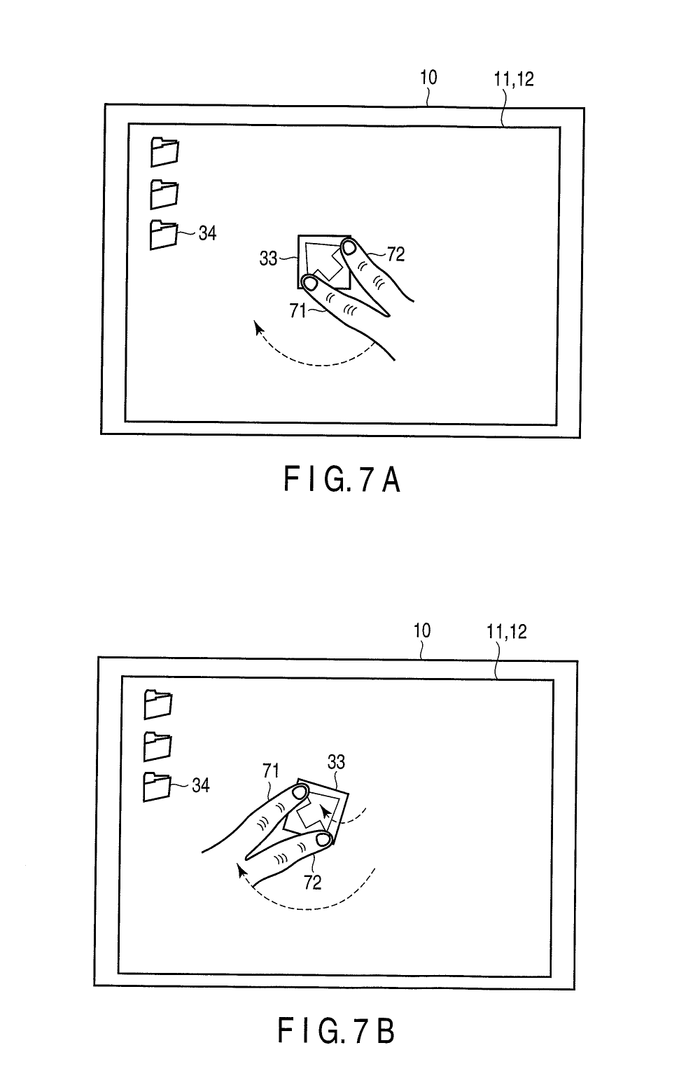

FIGS. 7A and 7B are views showing an example of a method of implementing a cursor display changing function according to this embodiment. FIGS. 7A and 7B show the PC 10, the LCD 11, the touch panel 12, the cursor 33, the folder 34, and fingers 71 and 72.

In this embodiment, the cursor display changing function is a function of the PC 10 by which the cursor 33 is rotated or scaled-up/scaled-down in accordance with a predetermined input operation by the user.

In this embodiment, when the user touches the display of the cursor 33 on the touch panel 12 with two fingers and rotates the fingers 71, 72 in the direction of an arrow as shown in FIG. 7A, the cursor 33 also rotates in the arrow direction as shown in FIG. 7B.

The rotated cursor 33 is redrawn so as to maintain the positional relationship between the contact points where the fingers 71 and 72 touch the cursor 33. That is, the point at which the cursor 33 is in touch with the finger 71 moves following the movement of the finger 71, and the point at which the cursor 33 is in touch with the finger 72 moves following the movement of the finger 72. The cursor 33 is rotated or scaled-up/scaled-down so as not to change the shape (the aspect ratio of the shape of the cursor 33) by the movements of the two points, thereby maintaining the shape. The PC 10 stores the contact points on the cursor 33, and draws the cursor 33 such that the contact points on the cursor 33 match the touch points on the touch panel 12 moved by the dragging operation. With this configuration, the user can rotate or scale-up/scale-down the cursor 33 by touching the display of the cursor 33 with two fingers 71, 72, and moving these fingers 71, 72. The rotation or scale-up/scale-down may also be implemented in combination with the movement.

Especially when the cursor 33 is displayed in a large size as in this embodiment, it is difficult to point the arrowhead of the cursor 33 toward the end of the LCD 11, i.e., in the opposite direction to the direction of the arrow. This is so because when pointing the arrowhead toward the end of the LCD 11, the finger protrudes from the screen of the LCD 11 and cannot be detected by the touch panel 12 any longer. When the cursor 33 is rotatable as in this embodiment, therefore, the direction of the arrow can appropriately be changed. Since this reduces cases in which it is difficult to point the arrowhead of the cursor 33 toward the corners (ends) of the screen, the user friendliness improves. Furthermore, in this embodiment, the user can appropriately change the size of the cursor 33, and use the cursor 33 in a suitable size in accordance with the method of using the cursor 33. This also improves the user friendliness.

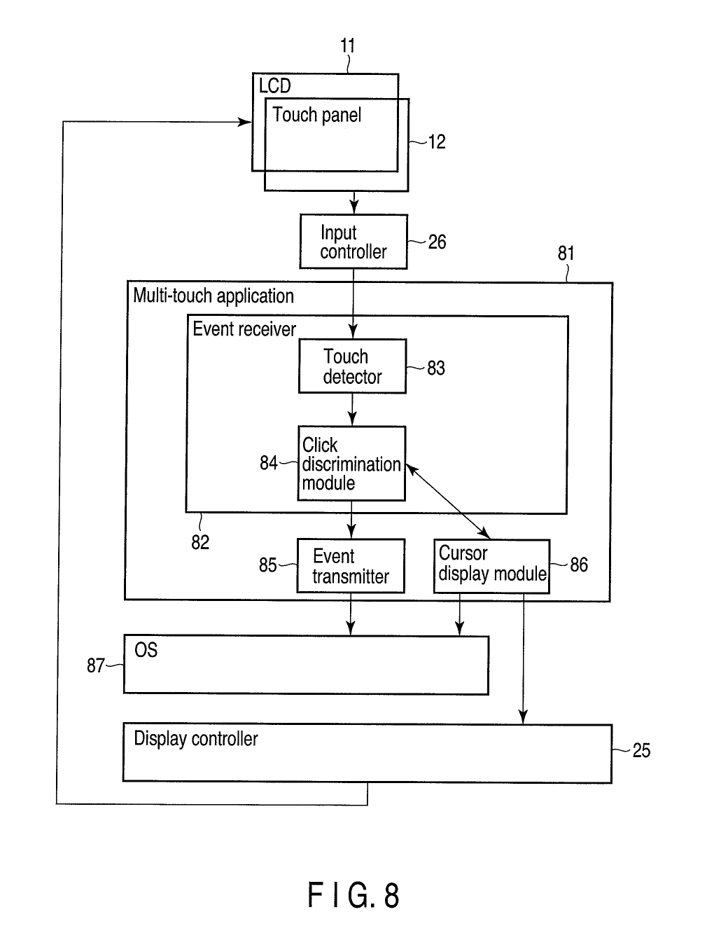

FIG. 8 is a functional block diagram showing examples of the functional blocks of the PC 10 according to this embodiment. FIG. 8 shows the LCD 11, the touch panel 12, the input controller 26, a touch input application 81, an event receiver 82, a touch detector 83, a click discrimination module 84, an event transmitter 85, a cursor display module 86, and an OS 87.

The touch input application 81 is an application for executing a touch input application program stored in the HDD 24. The touch input application 81 has a function of implementing touch input by controlling user input on the touch panel 12. The multi-touch application 81 has a function of performing various kinds of processing based on signal input from the input controller 26, and outputting various signals to the OS 87 and display controller 25. The touch input application 81 includes the event receiver 82, touch detector 83, click discrimination module 84, event transmitter 85, and cursor display module 86.

The input controller 26 has a function of receiving an electrical signal generated when the touch panel 12 detects the contact or proximity of an object such as a finger, and outputting the electrical signal to the touch detector 83 of the event receiver 82. As described above, the input controller 26 may receive the information of the simultaneous contact or proximity (multi-touch) of objects at two points on the touch panel 12.

The event receiver 82 has a function of receiving user's input operations on the touch panel 12 as various kinds of event information, and outputting various instructions to the event transmitter 85 and cursor display module 86.

The touch detector 83 has a function of calculating the contact or proximity point of an object as coordinate information on the touch panel 12, based on an electrical signal input from the multi-touch driver 81. Also, the touch detector 83 outputs the calculated coordinate information of the contact or proximity of an object to the click discrimination module 84 as needed. The touch panel 12 and touch detector 83 function as a coordinate information generating modules.

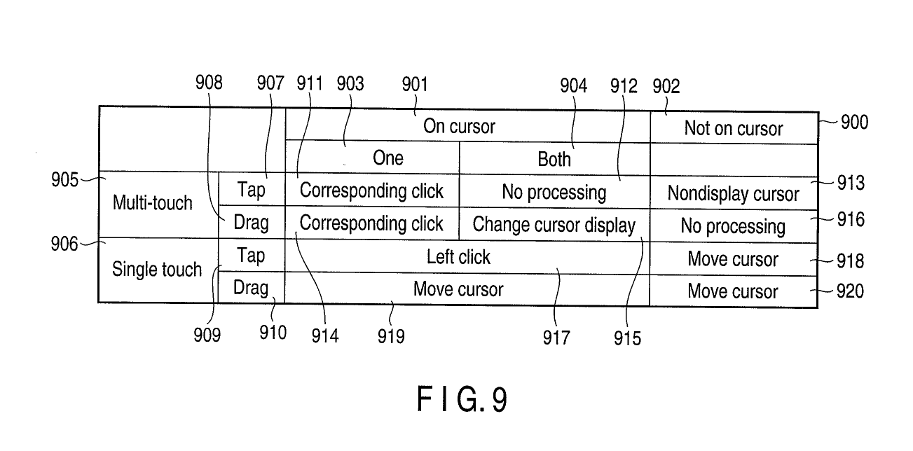

The click discrimination module 84 has a function of performing various discriminations based on the coordinate information of the contact or proximity point of an object on the touch panel 12, which is calculated by the touch detector 83, and giving various instructions to the event transmitter 85 and cursor display module 86 so as to perform processing based on the discrimination results. Examples of items discriminated by the click discrimination module 84 are whether the contact or proximity of an object to the touch panel 12 is a single touch or multi-touch, whether an input operation on the touch panel 12 is tapping or dragging, and whether the calculated coordinate information of the contact or proximity point of an object indicates coordinates on the cursor 33 on the LCD 11. The click discrimination module 84 discriminates whether an input operation on the touch panel 12 is tapping or dragging, by using its own timer (not shown). The discrimination of whether the coordinate information of the contact or proximity point of an object indicates coordinates on the cursor 33 will be described later. The click discrimination module 84 has a function of performing the above-mentioned discriminations, and performing processing based on combinations of the discriminations. The combinations and the processing based on the combinations will be described later with reference to FIG. 9.

The event transmitter 85 has a function of transmitting the process instruction received from the click discrimination module 84 to the OS 87.

The cursor display module 86 has a function of performing predetermined processing based on the process instruction and coordinate information received from the click discrimination module 84. The click discrimination module 84 transmits, to the cursor display module 86, an instruction to draw the cursor 33 and the coordinate information of the contact or proximity point of an object on the touch panel 12. The cursor display module 86 has the function of generating the shape of the cursor 33 in accordance with the instruction from the click discrimination module 84, and causing the display controller 25 to draw the cursor 33. Also, the cursor display module 86 transmits the generated shape of the cursor 33 and the position information to the click discrimination module 84. The cursor display module 86 further has a function of transmitting, to the OS 87, information indicating the position of the arrowhead of the cursor 33 on the display screen of the LCD 11.

The OS 87 is a program of controlling the whole PC 10. Even when the user is performing an input operation on the touch panel 12, the OS 87 operates in the same manner as when the user is performing an input operation by using the mouse or touch pad 14, except that no cursor is displayed. In this state, the OS 87 receives the coordinate information of the arrowhead of the cursor 33 from the cursor display module 86. When the user performs a clicking operation or the like, the OS 87 specifies the target selected by the click by using the coordinate information of the arrowhead of the cursor 33. Also, the OS 87 achieves the mouseover function when, e.g., the coordinate information of the arrowhead of the cursor 33 exists on a predetermined object.

The display controller 25 has a function of generating an image of the cursor 33 in accordance with the instruction to draw the cursor 33 received from the cursor display module 86, and causing the LCD 11 to display the image of the cursor 33.

FIG. 9 is a view showing examples of processing corresponding to the discrimination results by the click discrimination module 84. The PC 10 executes the processing. FIG. 9 shows a discrimination table 900.

The click discrimination module 84 discriminates a user's input operation based on the coordinate information of the contact or proximity point of an object on the touch panel 12, which is calculated by the touch detector 83, and the coordinate information of the display position of the cursor 33, which is calculated from the cursor display module 86. The click discrimination module 84 performs processing based on the determination result. In the cursor display phase of a flowchart (to be described later) according to this embodiment, the click discrimination module 84 discriminates a user's input operation and performs corresponding processing by referring to the discrimination table 900 shown in FIG. 9.

Fields (fields 901 and 902) of the uppermost row in the discrimination table 900 show a status (on cursor/not on cursor) indicating whether or not the coordinate information of the display position of the cursor 33 generated by the cursor display module 86 contains the coordinate information of the touch point (the contact or proximity point of an object will simply be referred to as the touch point hereinafter) generated by the touch detector 83. Fields (fields 903 and 904) of the second uppermost row show a status (one/both) indicating whether one or both of the pieces of coordinate information of the touch points of a multi-touch exist on the cursor when the above-mentioned status is “on cursor” and the input operation is a multi-touch. Fields (fields 905 and 906) of the leftmost column in the discrimination table 900 show a status (multi-touch/single touch) indicating whether the input operation is a multi-touch or single touch. Fields (fields 907 to 910) of the second leftmost column show a status (tap/drag) indicating whether the input operation is tapping or dragging.

Based on these input statuses, the click discrimination module 84 determines corresponding processing. For example, when the input operation is single-touch dragging and the coordinate information of the display position of the cursor 33 contains the coordinate information of the touch point, the click discrimination module 84 performs the process of moving the cursor 33 (a field 919). In this case, the cursor 33 moves following the movement of the touch point (in the same moving direction by the same moving amount as the touch point) as described previously with reference to FIG. 5.

The individual fields of the discrimination table 900 will be explained below.

A field 911 shows processing when the input operation is multi-touch tapping and only one touch point exists on the cursor 33. Whether to generate a left-click event or right-click event is determined based on the positional relationship between the touch point on the cursor 33 and a touch point not on the cursor 33. The left-click event is determined if the touch point not on the cursor 33 is on the left side of the touch point on the cursor 33, and the right-click event is determined if the touch point not on the cursor 33 is on the right side of the touch point on the cursor 33. The determined event information is transmitted to the OS 87 via the event transmitter 85.

A field 912 shows processing when the input operation is multi-touch tapping and both the touch points exist on the cursor 33. In this case, the click discrimination module 84 performs no processing.

A field 913 shows processing when the input operation is multi-touch tapping and both the touch points do not exist on the cursor 33. In this case, the click discrimination module 84 instructs the cursor display module 86 to stop displaying the cursor 33.

A field 914 shows processing when the input operation is multi-touch dragging and only one touch point exists on the cursor 33. In this case, a corresponding click event is generated in the same manner as in the processing in the field 911. Since this click is continuous pressing, the click discrimination module 84 transmits information indicating that the click is continuous pressing to the OS 87. This makes it possible to set the selection range in the region explained with reference to FIG. 5. It is also possible to input lines and the like by user's handwriting when, e.g., a drawing application or the like is executed.

A field 915 shows processing when the input operation is multi-touch dragging and both the touch points exist on the cursor 33. In this case, the click discrimination module 84 performs the cursor display changing process shown in FIG. 7. The click discrimination module 84 transmits the coordinate information of the two touch points of the multi-touch to the cursor display module 86. By using the received coordinate information, the cursor display module 86 regenerate the image of the cursor 33 based on the movements of the two touch points as described previously, thereby rotating or scaling-up/scaling-down the cursor 33.

A field 916 shows processing when the input operation is multi-touch dragging and both the touch points do not exist on the cursor 33. In this case, the click discrimination module 84 performs no processing.

A field 917 shows processing when the input operation is single-touch tapping and the touch point exists on the cursor 33. In this case, the click discrimination module 84 discriminates that left click is performed. Therefore, the click discrimination module 84 generates a left-click event, and transmits left-click event information to the OS 87 via the event transmitter 85. In this state, the arrowhead of the cursor 33 is the selected point (touch point).

A field 918 shows processing when the input operation is single-touch tapping and the touch point does not exist on the cursor 33. In this case, the click discrimination module 84 moves the display position of the cursor 33 to the touch point. The click discrimination module 84 transmits the coordinate information of the touch point on the touch panel 12 to the cursor display module 86, and instructs the cursor display module 86 to display the cursor 33 such that the coordinate point is the arrowhead. In response to the instruction, the cursor display module 86 generates the shape of the cursor 33, causes the display controller 25 to draw the cursor 33, thereby causing the LCD 11 to display the moved cursor 33. In addition, the cursor display module 86 transmits the coordinate information of the arrowhead of the cursor 33 in this state to the click discrimination module 84. With this configuration, the user can simply display the cursor 33 in a suitable position without tracing the screen of the touch panel 12 with a finger.

A field 919 shows processing when the input operation is single-touch dragging and the touch point exists on the cursor 33. In this case, the click discrimination module 84 transmits the coordinate information of the touch point to the cursor display module 86. The cursor display module 86 generates and displays an image of the cursor 33 so that the cursor 33 moves following the touch point.

A field 920 shows processing when the input operation is single-touch dragging and the touch point does not exist on the cursor 33. In this case, the click discrimination module 84 transmits the coordinate information of the touch point to the cursor display module 86. The cursor display module 86 displays the cursor 33 at the touch point so that the cursor 33 moves following the movement of the touch point.

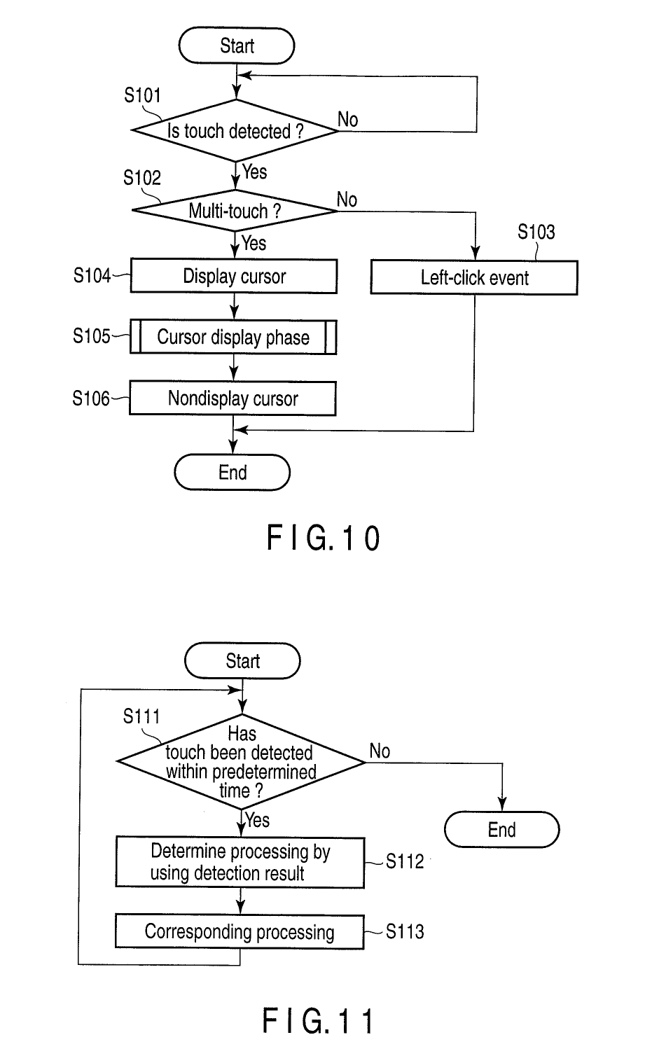

FIG. 10 is the flowchart showing an example of the procedure according to this embodiment. This procedure shown in FIG. 10 is assumed that the procedure starts from a state in which the cursor 33 is not displayed.

First, the PC 10 discriminates whether the touch panel 12 has detected the contact or proximity point of an object (S101). If the touch panel 12 has not detected the contact or proximity point of any object (No in step S101), the process returns to step S101. If the touch panel 12 has detected the contact or proximity point of an object (Yes in step S101), the input controller 26 transmits the detection result of the touch panel 12 as an electrical signal to the touch detector 83. The touch detector 83 then generates the coordinate information of the detected point from the received electrical signal, and transmits the coordinate information to the click discrimination module 84. When the click discrimination module 84 has received the coordinate information of the detected point, the click discrimination module 84 determines whether the number of contact or proximity points of objects on the touch panel 12 is two (a multi-touch) (S102). That is, the click discrimination module 84 determines whether the number of contact or proximity points of objects on the touch panel 12 is one (a single touch) or two (a multi-touch). If it is determined that there is only one contact or proximity point on the touch panel 12 (No in step S102), the click discrimination module 84 instructs the event transmitter 85 to transmit left-click event generation information to the OS 87. When the event transmitter 85 has received the instruction, the event transmitter 85 transmits left-click event generation information to the OS 87, and the OS 87 having received the information performs processing corresponding to left click (S103).

If the click discrimination module 84 determines that the input operation is a multi-touch (Yes in step S102), the click discrimination module 84 transmits the coordinate information of the touch points and instructs the cursor display module 86 to display the cursor 33. Based on the received instruction and coordinate information, the cursor display module 86 generates the shape of the cursor 33. Although the display position of the cursor 33 can be any position on the LCD 11 as described earlier, and the cursor display module 86 transmits the coordinate information of the cursor 33 to be displayed to the click discrimination module 84. The cursor display module 86 having generated the shape of the cursor 33 instructs the display controller 25 to generate an image of the cursor 33 and display the image on the LCD 11, thereby displaying the cursor 33 on the LCD 11 (S104). Also, the cursor display module 86 transmits the coordinate information of the arrowhead of the cursor 33 to the OS 87. When step S104 is complete, the process advances to a cursor display phase (S105). The cursor display phase will be described later with reference to FIG. 11. When the cursor display phase (S105) is complete, the click discrimination module 84 instructs the cursor display module 86 to stop displaying the cursor 33, and the cursor display module 86 having received the instruction interrupts the cursor display process and stops displaying the cursor 33 (S106). When steps S103 and S106 are complete, the process is terminated.

When displaying the cursor 33 in the cursor display area 42 as explained above with reference to FIG. 4, the determination in step S102 is “whether the detected contact point exists in the cursor display area 42”. The process advances to step S104 if the detected contact point exists in the cursor display area 42 (Yes in step S102), and advances to step S103 if not (No in step S102).

FIG. 11 is the flowchart showing an example of the procedure of the cursor display phase according to this embodiment. The processing of the cursor display phase in the procedure shown in FIG. 10 will be explained below with reference to FIG. 11.

First, in the state in which the cursor 33 is displayed, the click discrimination module 84 determines whether objects have touched or approached the touch panel 12 within a predetermined time (S111). Although the predetermined time is, e.g., 30 seconds in this embodiment, this is merely an example in this embodiment. If the contact or proximity of objects is detected within 30 seconds (Yes in step S111), the click discrimination module 84 discriminates the user's input operation and determines processing corresponding to the discrimination result with reference to the table shown in FIG. 9, by using the coordinate information of the touch point on the touch panel 12 and the coordinate information of the display position of the cursor 33 (S112). In accordance with the processing determined by the click discrimination module 84, the click discrimination module 84, event transmitter 85, cursor display module 86, OS 87, display controller 25, and the like perform the corresponding one of the various kinds of processing described previously with reference to FIG. 9 (S113). When step S113 is complete, the process returns to step S111. If the click discrimination module 84 does not detect the contact or proximity of objects within 30 seconds (No in step S111), the cursor display phase is terminated, and the process advances to step S106 in FIG. 10.

When the contact or proximity of objects is detected at points on the display screen, the PC 10 according to this embodiment can emulate a mouse operation corresponding to each detected point. This makes it possible to realize an information processing apparatus which a user can intuitively operate.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display configured to display image information on a display screen;
a coordinate information generator configured to detect whether first and second detection points of the display screen are simultaneously contacted with or substantially close to objects, and to generate coordinate information of the first and second detection points;
a cursor display configured to display a cursor on the display screen; and
a processor configured to generate a predetermined event which corresponds to an input operation of a mouse, in accordance with the coordinate information of the second detection point, when the coordinate information generator detects that the first and second detection points are contacted with or substantially close to the objects and the first detection point is on the cursor.

2. The apparatus of claim 1, wherein the processing module is configured to cause the cursor display module to display the cursor in a display position as a destination of a movement of the first detection point when detecting that the first detection point is continuously moving.

3. The apparatus of claim 1, wherein the processor is configured to generate an event corresponding to a left click of a mouse input operation if the coordinate information of the second detection point indicates a left side of the coordinate information of the first detection point when viewed from a user's side, and to generate an event corresponding to a right click of the mouse input operation if the coordinate information of the second detection point indicates a right side of the coordinate information of the first detection point.

4. The apparatus of claim 1, wherein the cursor display is configured to switch between displaying and hiding of the cursor on the display screen, and
the processor is configured to cause the cursor display to display the cursor, when the coordinate information generator detects that objects are simultaneously contacted with or substantially close to two points on the display screen, or objects are sequentially contacted with or substantially close to two points on the display screen within a predetermined time while the cursor display is hiding the cursor.

5. The apparatus of claim 1, wherein the cursor display is configured to switch between displaying and hiding of the cursor,
the display is configured to display a predetermined area, and
the processor is configured to cause the cursor display to switch between displaying and hiding of the cursor when the first and second detection points detected by the coordinate information generator are within the predetermined area.

6. The apparatus of claim 1, wherein the cursor display is configured to move a first point on the cursor comprising the coordinate information of the first detection point, and a second point on the cursor comprising the coordinate information of the second detection point, by the amount of the changes in coordinate information of the first detection point and the second detection point, in order to scale-up, scale-down or rotate the cursor in such a manner that positions of the first point and the second point on the cursor match positions on the previously displayed cursor, and to redraw and display the cursor, when the first and second detection points detected by the coordinate information generator are on the cursor while at least one of the first and second detection points is moving.

7. The apparatus of claim 1, wherein the cursor display is configured to display the cursor in a larger size than the size of a cursor displayed while a mouse is operated.

8. The apparatus of claim 1, further comprising a mouseover module configured to display predetermined information corresponding to a predetermined position on the display screen, if the cursor is in the predetermined position for more than a predetermined period.

9. A non-transitory computer readable medium having a computer program stored thereon that is executable by a computer to control the computer to execute functions of:
causing a coordinate information generator to detect whether first and second detection points of the display screen are simultaneously contacted with or substantially close to objects, and to generate coordinate information of the first and second detection points, when displaying image information on a display screen;
causing a cursor display to display a cursor on the display screen; and
causing a processor to generate a predetermined event which corresponds to an input operation of a mouse, in accordance with the coordinate information of the second detection point, when the coordinate information generator detects that the first detection point is on the cursor.

10. A pointing method for an information processing apparatus, comprising:
displaying image information on a display screen;
displaying a cursor on the display screen;
detecting whether first and second detection points are simultaneously contacted with or substantially close to objects on the display screen, and generating coordinate information of the first and second detection points; and
generating a predetermined event which corresponds to an input operation of a mouse, in accordance with the coordinate information of the second detection point, when it is detected that the first and second detection points are contacted with or substantially close to objects and the first detection point is on the cursor.
